(19) United States
(12) Patent Application Publication
(10) Pub. No.: US 2018/0351182 A1
(43) Pub. Date: Dec. 6, 2018

(54) CONNECTOR SYSTEM FOR A FUEL CELL STACK

(71) Applicant: Intelligent Energy Limited, Loughborough (GB)

(72) Inventor: Peter David Hood, Loughborough (GB)

(73) Assignee: Intelligent Energy Limited, Loughborough (GB)

(21) Appl. No.: 15/777,017

(22) PCT Filed: Nov. 24, 2016
(86) PCT No.: PCT/GB2016/053694

§ 371 Date: May 17, 2018

(30) Foreign Application Priority Data
Nov. 27, 2015 (GB) 1520981.0

(51) Int. Cl. H01M 8/0247; H01M 8/0258; H01M 8/2465

(52) U.S. Cl. CPC H01M 8/0247; H01M 8/2465; H01M 8/0258

(57) ABSTRACT

A fluid flow field plate for an electrochemical fuel cell comprises an electrically conductive plate element having a peripheral edge encapsulated in an electrically insulating gasket material. The plate element has a laterally projecting tab with a first face covered by the peripheral gasket material and a second face at least partially exposed through the gasket material. One or more edges of the laterally projecting tab may thereby be covered and protected by the peripheral gasket material and the gasket material of multiple stacked plates may together define a housing structure for a plurality of connection tabs also serving as a receptacle for receiving a connector module. A fuel cell stack assembly may have a layered construction including electrically conductive fluid flow field plates at least partially separated by gasket layers. The gasket layers each have at least one exposed edge that together define an open face of the stack assembly. The gasket layers each define a recess in the exposed edge. Each recess is configured to receive an electrical connector for making electrical connection to the respective electrically conductive fluid flow plate adjacent to the recess.

The present invention relates to electrical connector systems used in fuel cell stacks to make electrical connections to a plurality of individual cells within a fuel cell stack.

Conventional electrochemical fuel cells convert fuel and oxidant into electrical and thermal energy and a reaction product. A typical fuel cell comprises a membrane-electrode assembly (MEA) sandwiched between an anode flow field plate and a cathode flow field plate. Gas diffusion layers may be disposed between each flow field plate and the MEA. Gaskets may be used to separate various layers and to provide requisite seals. The flow field plates typically include one or more channels extending over the surface of the plate adjacent to the MEA for delivery of fluid fuel or oxidant to the active surface of the MEA. The flow field plates also perform the function of providing an electrical contact to the MEA across the surface thereof.

In a conventional fuel cell stack, a plurality of cells are stacked together, so that the anode flow field plate of one cell is adjacent to the cathode flow field plate of the next cell in the stack, and so on. In some arrangements, bipolar flow plates are used so that a single flow field plate has fluid flow channels in both sides of the plate. One side of the bipolar plate serves as an anode flow plate for a first cell and the other side of the flow plate serves as a cathode flow plate for the adjacent cell. Power can be extracted from the stack by electrical connections made to the first and last flow plate in the stack. A typical stack may comprise many tens or even hundreds of cells. The present invention is relevant to all of these various fuel cell stack constructions.

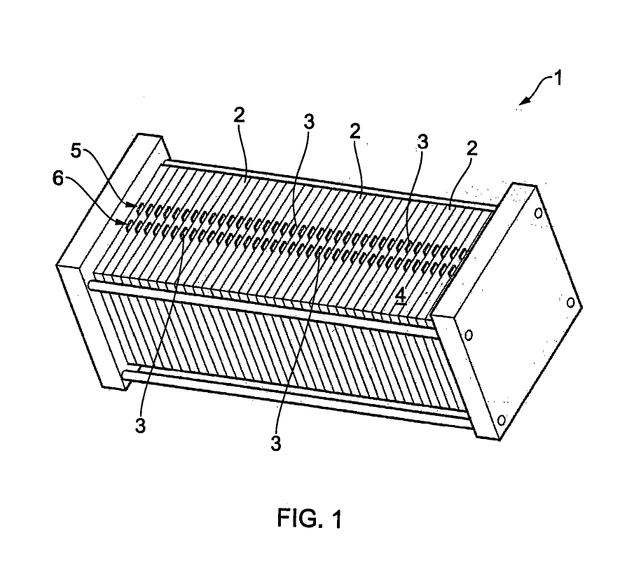

In many fuel cell stacks, it is important to be able monitor the voltage of individual cells in the stack. Thus, it is necessary to provide electrical connection to many (and often to all) of the flow plates in the stack. Conventionally, this has been achieved by providing electrical connector tabs to at least some of the flow plates in the stack. These cell voltage monitoring tabs extend from edges of the flow plates, laterally outward from the stack thereby forming an array of tabs along an edge face of the stack, so that individual electrical connectors may be coupled to each tab. One arrangement of cell voltage monitoring tabs extending from each flow plate is shown in FIG. 1.

The fuel cell stack 1 in FIG. 1 has a plurality of physically parallel cells 2 each of which has an anode flow plate (or a bipolar flow plate) with a respective tab 3 extending outwards from a face 4 of the fuel cell stack. To decrease the packing density of the tabs (i.e. to increase the separation of adjacent tabs) or to provide additional connection points to the same or different plates in the stack, the tabs 3 may be formed in two (or more) rows 5, 6.

These male tabs 3 can typically be used with standard female electrical connectors, such as blade receptacles well known in the art. Use of individual blade receptacles for each tab 3 is practical for manufacture of small stacks and small volumes of cells, but is not ideal for mass production of cells in view of the high labour content of connecting individual receptacles.

One potential disadvantage to the laterally extending tabs 3 is that they are exposed and relatively prone to damage during handling of the plates, during assembly of the fuel cell stack, during attachment of suitable electrical connectors and during use of the stack. Another potential disadvantage to the laterally extending tabs 3 is that if multiple rows of tabs are required as shown, to decrease packing density, then two or more different configurations of plates is required having tabs in different positions on the plates. This increases manufacturing costs, inventory costs, and stack assembly process complexity.

It is an object of the invention to provide a fuel cell field plate with an improved facility for electrical connection thereto.

According to one aspect, the present invention provides a fluid flow field plate for an electrochemical fuel cell comprising an electrically conductive plate element having a peripheral edge encapsulated in an electrically insulating gasket material, the plate element having a laterally projecting tab with a first face covered by the peripheral gasket material and a second face at least partially exposed through the gasket material.

At least one edge of the laterally projecting tab may be covered by the peripheral gasket material. At least two edges of the laterally projecting tab may be covered by the peripheral gasket material. The leading edge of the laterally projecting tab may be covered by the peripheral gasket material. The gasket material may define a retention feature for retaining an electrical connector coupled to the laterally projecting tab. The retention feature may comprise a barb on an exposed surface of the gasket material extending over the laterally projecting tab. The retention feature may comprise a ribbed exposed surface of the gasket material overlying the first face. The fluid flow field plate may comprise a bipolar plate having fluid distribution channels in both faces of the electrically conductive plate element.

The electrically insulating gasket material may extend around the complete periphery of the electrically conductive plate element, and may define fluid distribution channels in the gasket material on at least one peripheral edge of the plate element and may define a protective structure for the laterally projecting tab on at least one different peripheral edge of the plate element.

The fluid flow field plate may further include fluid coolant flow channels defined in the first face of the laterally projecting tab and/or in the gasket material covering the first face of the laterally projecting tab.

The laterally projecting tab may define a retention feature for retaining an electrical connector coupled to the laterally projecting tab. The retention feature may comprise a contoured or profiled exposed surface of the laterally projecting tab.

The fuel cell stack may comprise a plurality of layers, in which at least some of the layers each comprise a fluid flow field plate as defined above, thereby defining a plurality of electrically conductive connection tabs extending outwardly from at least one face of the stack, each electrically conductive connection tab being protected on plural edges by the gasket material of the plurality of layers, the gasket material collectively defining a housing structure for the plurality of connection tabs.

The housing structure may comprise two end walls protecting edges of the connection tabs and defining a receptacle therebetween for receiving an electrical connector module. The fuel cell stack may further include an electrical connector module configured to engage with the plural electrically conductive connection tabs and the gasket material for separate electrical connection to each of the tabs. The electrical connector module may engage with retention features disposed on the gasket material. The retention features may comprise one or more of a barb or barbs on the housing structure and ribbed exposed surfaces of the gasket material of the housing structure. The width of the electrical connector module may be substantially less than the width of the electrically conductive connection tabs such that the electrical connector module can be engaged with the tabs at a number of different positions along a peripheral edge of the stack and/or such that multiple such electrical connector modules could be engaged with tabs of the stack simultaneously at different positions along the peripheral edge of the stack.

The electrical connector module may comprise a plurality of blades spaced from one another with a pitch that is equal to or an integer multiple of the pitch of the plates in the stack, each blade comprising a spring metal component for engagement with the second face of a laterally projecting tab and for simultaneous engagement with the gasket material covering the first face of an opposing, adjacent laterally projecting tab.

According to another aspect, the invention provides a fuel cell stack assembly having a layered construction including electrically conductive fluid flow field plates at least partially separated by gasket layers, the gasket layers each having at least one exposed edge that together define an open face of the stack assembly,
the gasket layers each defining a recess in the exposed edge, each recess being configured to receive an electrical connector for making electrical connection to the respective electrically conductive fluid flow plate adjacent to the recess.

Each recess may extend through only a portion of the thickness of the respective gasket layer, each recess thereby being defined on a first side by one of said electrically conductive fluid flow plates and on a second side by the gasket material. Each gasket layer may lie between a portion of a cathode plate and an anode plate. Each gasket layer may define a retention feature associated with a respective recess. The retention feature may comprise a ribbed surface within the recess. The electrically conductive fluid flow plate may define a retention feature associated with a respective recess. The retention feature may comprise a contoured or profiled exposed surface of the electrically conductive fluid flow plate associated with a respective recess. The cathode plate may comprise a corrugated plate, and each gasket layer may correspond in thickness with the corrugation height. The gasket layers and the electrically conductive flow pates may each have at least one exposed edge that together define the open face of the stack assembly. The fuel cell stack may further include a coolant flow channel defined in the electrically conductive plate and/or the gasket, the coolant flow channel being in a position overlying the recess.

According to another aspect, the invention provides a method of making electrical connections to flow field plates of a fuel cell stack comprising:
forming a plurality of fluid flow field plates each comprising an electrically conductive plate element having a peripheral edge encapsulated in an electrically insulating gasket material, the plate element having a laterally projecting tab with a first face covered by the peripheral gasket material and a second face at least partially exposed through the gasket material;
stacking the fluid flow field plates together to form a fuel cell stack with aligned laterally projecting tabs, such that the gasket material defines a housing for said tabs.

The method may further comprise connecting an electrical connector module to said tabs by engagement into a receptacle defined by the housing, wherein the engagement of the electrical connector module is with the tabs and the gasket material.

According to another aspect, the invention provides a method of making electrical connections to flow field plates of a fuel cell stack comprising:
forming a fuel cell stack assembly having a layered construction including electrically conductive fluid flow field plates separated by gasket layers, the gasket layers each having at least one exposed edge that together define an open face of the stack assembly, the gasket layers each defining a recess in the exposed edge;
inserting an electrical connector into each recess to make electrical connection to the respective electrically conductive fluid flow plate that is adjacent to the recess.

Embodiments of the present invention will now be described by way of example and with reference to the accompanying drawings in which:

FIG. 1 shows a schematic perspective view of a prior art fuel cell stack with conventional cell voltage monitoring tabs extending outwards from a face of the fuel cell stack;

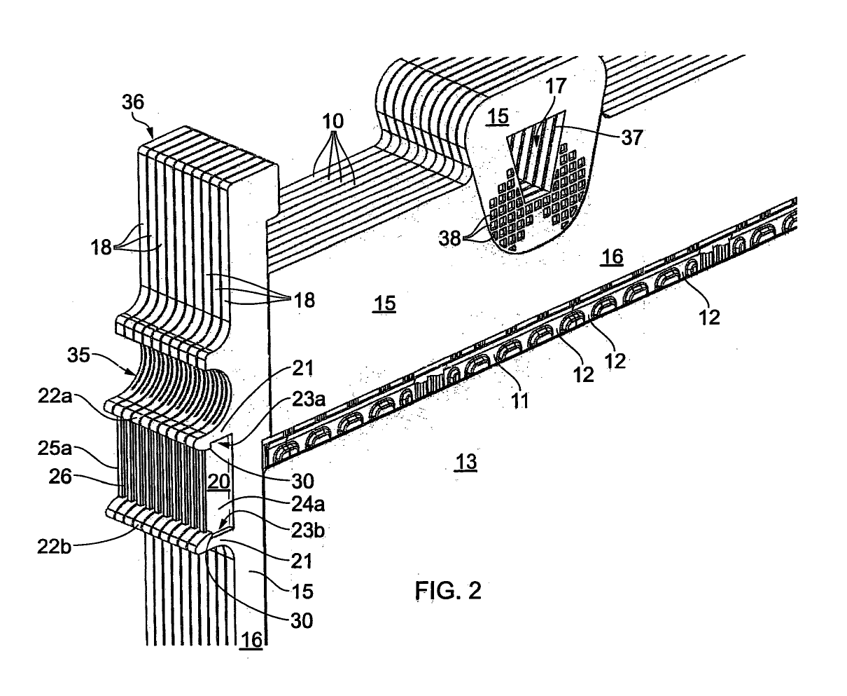

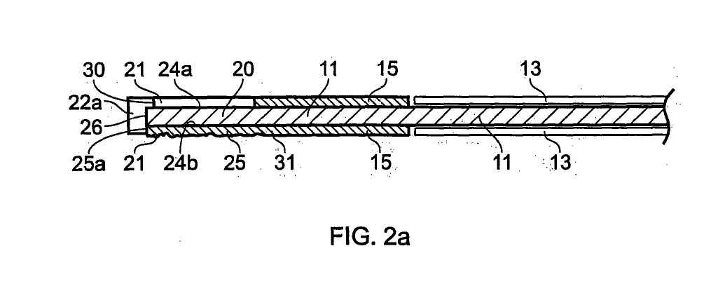

FIG. 2 shows a perspective view of a corner section of a partial stack of ten flow field plates showing a gasket housing electrically conductive connection tabs which each extend laterally from a peripheral edge of a respective flow field plate;

FIG. 2a shows a cross-sectional view through one of the flow field plates of FIG. 2, at a mid-point of the electrically conductive connection tab;

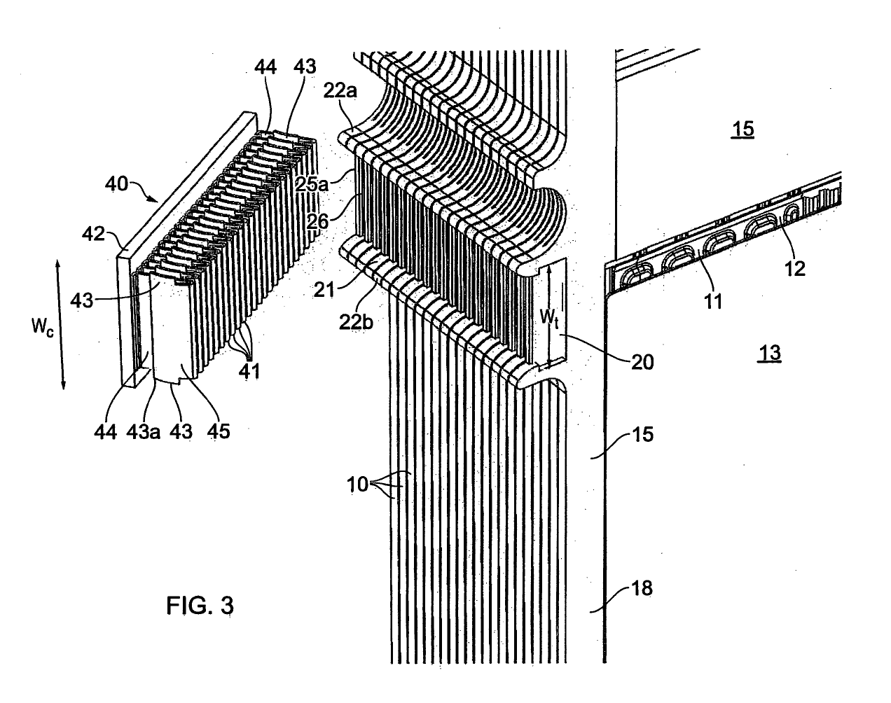

FIG. 3 shows a perspective view of the corner section of the stack of FIG. 2, also showing an electrical connector module for attachment thereto;

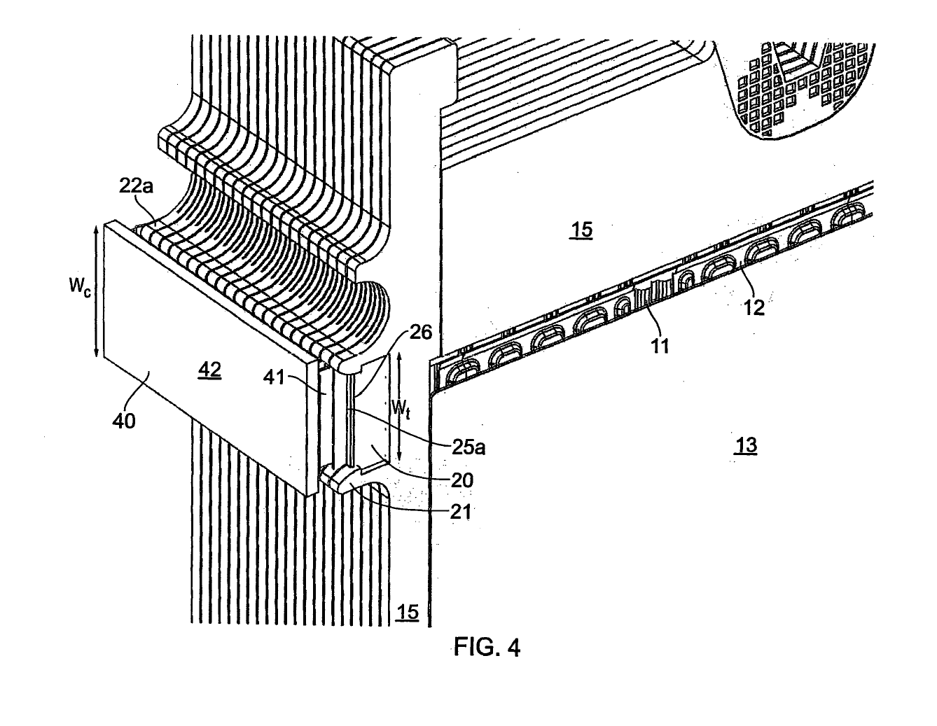

FIG. 4 shows a perspective view of the corner section of the stack and connector module of FIG. 3, with the connector module coupled to the stack;

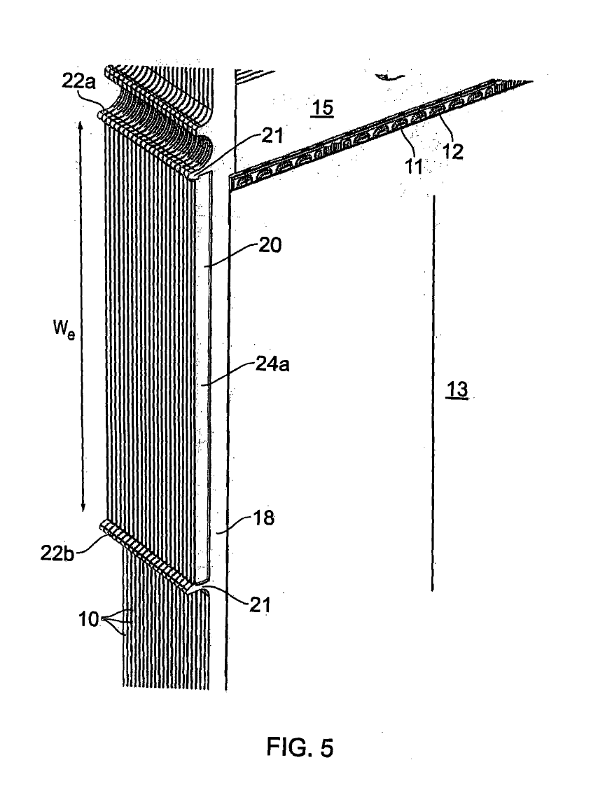

FIG. 5 shows a perspective view of a corner section of a stack similar to FIG. 2, but with an array of extended width electrically conductive connection tabs;

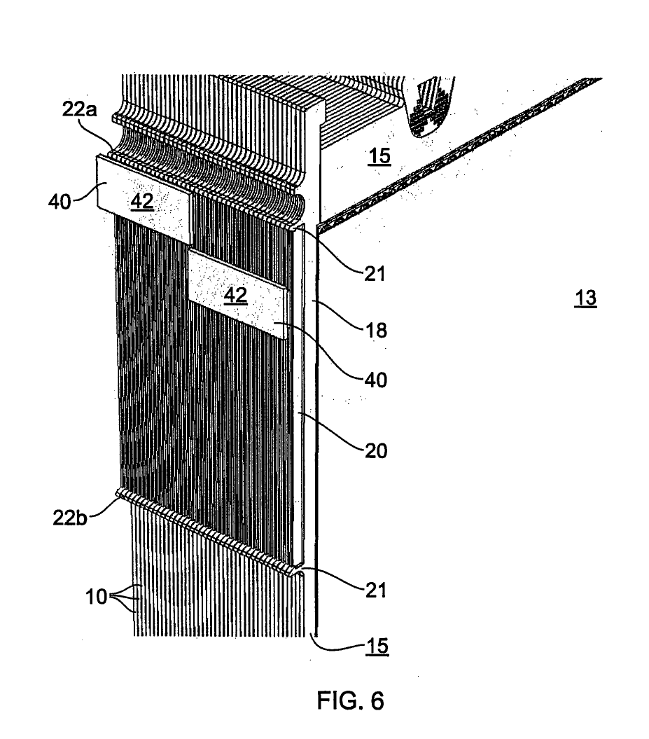

FIG. 6 shows a perspective view of the stack of FIG. 5 showing two electrical connector modules coupled at different width positions of the array of electrically conductive connection tabs;

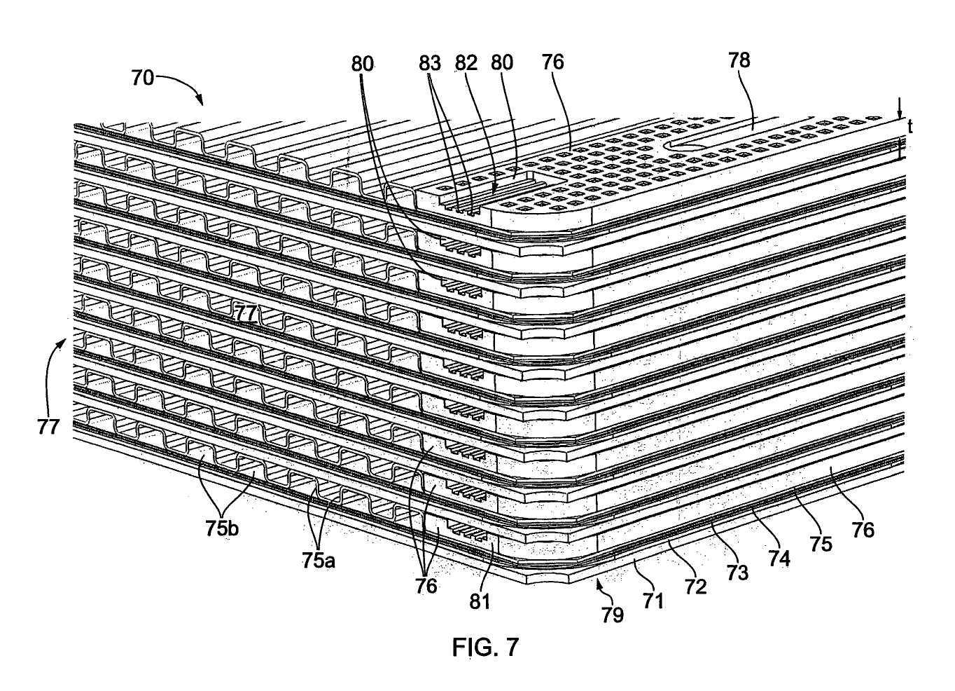

FIG. 7 shows a perspective view of a part of an open cathode fuel cell stack assembly (nine cells being shown; more may be stacked thereon);

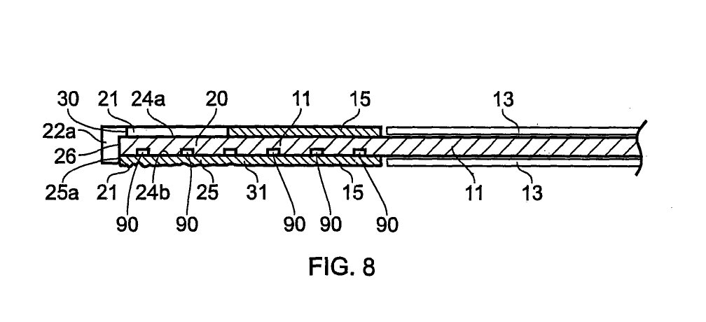

FIG. 8 shows a cross-sectional view through one of the flow field plates similar to FIG. 2a, adapted to provide fluid cooling to the electrically conductive connection tab.

FIG. 2 shows a stack of fluid flow field plates 10 for an electrochemical fuel cell stack. The number of plates 10 is merely illustrative and it will be understood that this forms a part of a fuel cell stack, in which a larger or smaller number of plates 10 may be used. In the example being described here, each plate 10 is a bipolar plate, though separate anode and cathode plates may be used.

Each plate 10 comprises an electrically conductive plate element 11 which provides an active field area of the plate and may include a set of fluid flow distribution channels 12 in the surface thereof for flow of anode or cathode fluid across the active field area. The flow channels 12 are covered by one or more gas diffusion layers 13 and a membrane electrode assembly which, in FIG. 2, are partially cut away to reveal the flow channels 12 behind. Gas diffusion layers 13 may generally be laid on top of the electrically conductive plate element 11 during assembly of a stack. For a bipolar plate, fluid flow channels 12 may be provided on both faces of the plate element 11.

Each electrically conductive plate element 11 (which may be referred to as a plate insert) has a peripheral edge which is encapsulated in an electrically insulating gasket material 15. The gasket material 15 is preferably formed as an overmoulded gasket 18 which is bonded to the electrically conductive plate element 11 and comprises a resilient elastomeric/rubber compound which provides a sealing surface 16 surrounding the plate element 11 edge on both faces and optionally also around one or more fluid distribution plenums 17 at one or more edges of the plates for delivery of fluids to the flow channels 12 in each plate 10.

Each electrically conductive plate element 11 also includes a laterally projecting tab 20 extending from the active field area of the plate and preferably from a peripheral edge of the plate element 11. Preferably the plate element 11 and the laterally projecting tab 20 are of a unitary construction, e.g. formed from a sheet of metal such as stainless steel stamped out or otherwise cut and formed to the appropriate shape, prior to being introduced to an overmoulding process to form the peripheral gasket around the peripheral edge of the cut sheet.

As seen in FIG. 2, the gasket 18 provides a housing structure 21 comprising first and second end walls 22a, 22b which protect and encompass or envelop respective first and second side edges 23a, 23b of the tab 20. The tab 20 comprises an exposed face 24a visible in FIG. 2, and a concealed face 24b on the reverse side of the tab 20, not visible in FIG. 2, but shown in FIG. 2a which represents a cross-section through one plate element 11 and tab 20 at a midpoint between end walls 22a, 22b looking towards the end wall 22a. More generally, the concealed face 24b may exemplify a first face of the tab 20 and the exposed face 24a may exemplify an opposing second face of the tab 20. The first face is covered by the gasket material 15 by a covering part 25 of the housing structure 21 which extends between the first and second end walls 22a, 22b. The leading edge 25a of the covering part 25 is visible in FIG. 2. The leading edge 26 of tab 20 is visible immediately adjacent to the leading edge of housing part 25. The second face 24a of the tab 20 is at least partially exposed through the gasket material 15. The housing structure 21, e.g. at the first and second end walls 22a, 22b, preferably provides a small amount of overlap onto the peripheral portions of the second face 24a as well as covering the first and second side edges 23a, 23b.

As can be seen in FIG. 2, the housing structure 21 defined by the gasket material 15 provides for the tabs 20 to be recessed within the gasket material for protection.

The housing structure 21 preferably defines one or more retention features for retaining an electrical connector assembly that may be removably coupled to the tab or tabs 20.

One such type of retention feature may comprise a barb 30 projecting inwards from one or both end walls 22a, 22b. The end walls 22a, 22b may be configured to elastically deform as a connector assembly is pushed onto the tabs 20 within the housing structure 21 and then resiliently return to capture a feature of the connector assembly when that feature has passed the barb 30 and is fully engaged.

Another type of retention feature may comprise a ribbed exposed surface 31 of the gasket material 15 covering the first face 24b of the tab 20, as seen in FIG. 2a. The ribbed surface 31 may comprise a suitably contoured or profiled surface of the gasket material which enhances the friction between a connector blade of a connector assembly (described later in connection with FIG. 3, for example) when passing into the housing structure 21 to couple with an exposed portion 24a of the tab 20 of an adjacent plate 10 in the stack which opposes the ribbed surface 31. The ribbed surface 31 may comprise a series of detents, ridges, ripples, notches or other surface texture or surface profile features which cooperate with or interengage with features of such a connector blade.

In addition, or instead, a retention feature may be provided on the exposed surface 24a of the tab 20, e.g. as a suitably contoured or profiled surface of the tab 20 which enhances the friction between a connector blade of a connector assembly (described later in connection with FIG. 3, for example) when passing into the housing structure 21. The contoured or profiled exposed surface 24a of the tab 20 may comprise a ribbed surface, one or more ridges or pips or similar to assist in retention of a connector blade, e.g. by engagement with a corresponding feature (e.g. receiving surface) of connector blade.

The gasket material 15 preferably extends around the complete periphery of the electrically conductive plate element 11 for most fuel cell stack types excepting the leading edge 26 of the tab 20. However, in other embodiments one or more edges or parts of edges of the plate element 11 may not require a continuous gasket, e.g. for open cathode type fuel cell plates.

The gasket material 15, i.e. gasket 18, may include other features. These may include recesses 35 each suitable for receiving a tie bar for compressing all the plates 10 together in a stack, and other projecting members 36 for engaging with or mounting stack support structures, air flow boxes etc. The gasket material 15 may generally be profiled, on the edge of the plate 10 that provides the tab 20, such that the housing 21 extends along the entire edge (or a substantial portion thereof), providing one or more specific recesses for the tabs 20.

The gasket 18 may also define fluid distribution channels such as those ending at openings 37 opening from the fluid distribution plenum 17. These channels may be configured for delivery of fluid from the distribution plenum 17 to selected ones of the flow channels 12. The fluid distribution channels may be provided on at least one, and preferably two, peripheral edges of the plate 10, typically opposite edges of the plate 10, and typically on edges of the plate different (e.g. adjacent to) the edge or edges defining the laterally extending connection tabs 20. The gasket material 15 may also include regions of enhanced compressibility, such as provided by cavities 38.

With reference to FIG. 3, it can be seen that the housing structure 21 defined by the gasket material 15 of the stacked plates 10 effectively provides a receptacle or recess into which an electrical connector module 40 may be received. In the example of FIGS. 2 and 3, the receptacle provided by the housing structure 21 may be considered to include the end walls 22a, 22b and the covering parts 25 extending therebetween between each pair of tabs 20.

The connector module 40 comprises a series of electrically conductive blades 41 extending outwards from a substrate 42 and spaced at intervals corresponding to the spacing of the plates 10 or integer multiples thereof. Each blade 41 may include a lug portion 43 which will co-operate with the barb 30 retention feature on the housing 21. The lug portion 43 may compress and/or displace the barb 30 as it slides past during engagement of the connector module 40 with the receptacle defined by housing 21, and then be retained behind the barb 30 when the trailing shoulder 43a of the lug portion 43 has passed the barb and the gasket material elastically recovered its position.

The blades 41 may each comprise a spring metal component folded back on itself as shown, having a main blade portion 44 coupled to the substrate 42 and a leaf spring portion 45 folded back on the main blade portion 44 but slightly separated therefrom, so as to provide a blade with an effective compressible thickness. Upon insertion of a blade 41 into a respective part of the housing 21, the main blade portion 44 bears against the exposed face 24a of a tab 20, and the leaf spring portion 45 bears against a covering part 25 of an adjacent tab 20. The retention feature of the ribbed surface 31 if present may assist in retaining the blade 41 in the receptacle. The leaf spring portions 45 of the blades 41 ensure that the main blade portion 44 is pressed firmly against the respective exposed face 24a. The main blade portion 44 and the leaf spring portion may be slightly arcuate in form, as shown in the drawings, to assist in ensuring good sliding engagement and good physical contact for electrical connection. It would also be possible to provide alternative configurations of blade 41, suitable for making optimal contact with both the exposed face 24a of a tab 20 and an opposing covering part 25 of an adjacent tab.

Thus, in a general aspect, the blades 41 may be spaced from one another with a pitch that is equal to or an integer multiple of the pitch of the plates 10 in the stack, and each blade may comprise a spring metal component 44, 45 that engages with the second (exposed) face 24a of a laterally projecting tab 20 and simultaneously may engage with the gasket material 25 covering the first (covered) face 24b of an opposing, adjacent laterally projecting tab 20.

The substrate 42 of the connector module 40 may comprise a printed circuit board or similar material which can be configured to have electrically conductive tracks thereon each providing an electrical connection to a respective blade 41.

FIG. 4 illustrates the connector module 40 inserted into the receptacle defined by housing 21, by simple push fit.

FIG. 5 illustrates a variation on the connection system exemplified in FIGS. 2 to 4. In FIGS. 2 to 4, the connection module 40 has a width w, which closely corresponds with the tab width wₜ within the housing 21, so that the connection module generally fills the receptacle defined by the housing. In the arrangement of FIG. 5, the housing 21 contains tabs 20 of an extended width wₑ providing a much larger surface area of exposed tab face 24a. In such an arrangement, as seen in FIG. 6, the connection modules 40 can be made of the same width and be positioned anywhere along the width of the tabs 20. This allows flexibility in the positioning of the connection modules 40 depending on other infrastructure surrounding the fuel cell stack. It also allows for staggered positions of connection modules (as shown) if restricted space prevents multiple connection modules from being placed in line with one another down the stack.

The extended width tab arrangement also facilitates use of multiple connection modules 40 in parallel with one another (i.e. coupled to the same tabs) should it be necessary to draw a higher current from individual intermediate plates in the stack than would normally be required for simple voltage monitoring.

The connection modules 40 may also be configured with blades 41 only at selected plate positions in the stack, e.g. the blades may be double spaced to only intercept alternate tabs 20 in the stack. For example, a first connection module 40 may comprise blades 41 positioned for engagement at odd numbered plate tab positions, and a second connection module 40 may comprise blades 41 positioned for engagement at even numbered plate tab positions. The connection modules 40 may thereby be positioned side-by-side on the wide tab housing of FIG. 6.

The configurations of electrically conductive connection tabs as described offer a number of advantages. The tabs may be protected by the gasket material within a one piece overmoulded gasket which is conveniently fabricated at one time. The tabs are less susceptible to damage. The gasket material may provide a compressible, high friction surface to assist in retaining an electrical connection module when plugged in. The increased protection for the tabs using the gasket material may enable tabs of extended length which can then provide flexibility in connector positioning, and/or extended tab surface area for extended dimension connectors or multiple connectors for higher current draw from a tab or tabs. This feature can be useful when sometimes it can be advantageous to short circuit selected cells or draw very high current from selected cells, such as during stack start-up, stack conditioning or stack protection operations.

The partial encapsulation of the tabs by the housing 21 provides improved durability during assembly and use and improved durability of the plates 10 prior to assembly, e.g. during shipping and handling. There may also be advantages in providing extended width tabs such that current can be drawn from a plate along substantially an entire edge of the plate, for improved current distribution across the surface area of the plate. Different connectors may be applied to accommodate both voltage sensing and current draw using different connector systems.

The laterally projecting tabs 20 may generally be exemplified by an edge part of the electrically conductive plate element 11 which projects laterally outward from an active field area of the plate element, or an otherwise generally rectangular outline of the plate element, such that it is capable of providing an exposed, projecting element extending from a face of a stack defined by plural plate 10 edges. Alternatively, or in addition, the laterally projecting tabs 20 may generally be exemplified by a limited area portion of the electrically conductive plate element which lies laterally outside an inner perimeter of gasket material used to seal adjacent plates together in a stack.

The housing 21 protecting the tabs is shown in the drawings as protecting, i.e. covering, two side edges 23a, 23b. In other arrangements, a more limited form of protection may be had by the housing covering only one side edge 23a or 23b. In the drawings (e.g. FIG. 2a), the leading edge 26 of the tab 20 is shown as being exposed, though partially protected and supported by the adjacent underlying tab covering part 25 with its leading edge 25a substantially coincident with tab leading edge 26. However, in an alternative arrangement, the covering part 25 could be configured to wrap around the tab leading edge 26 for additional edge protection. Thus, in a general aspect, one, two or three edges of the laterally projecting tab may be covered by the peripheral gasket material.

As is apparent from the foregoing description, the embodiments described above provide for a general method of making electrical connections to flow field plates 10 of a fuel cell stack. The method may include forming a plurality of the fluid flow field plates 10 and stacking the fluid flow field plates together to form a fuel cell stack with aligned laterally projecting tabs 20, such that the gasket material 15 defines the housing 21 for the tabs. An electrical connector module 40 can then be coupled to the tabs 20 by engaging the connector module into the receptacle defined by the housing 21. It can be seen that the engagement of the electrical connector module 40 is robust in that the module can be engaged with both the tabs 20 (at surface 24a) and the gasket material 15, e.g. at covering part 25 and/or retention feature comprising barb 30.

The principles described above can also be adapted to fuel cell stacks in which the gasket material presents an exposed edge which at least in part defines an open (e.g. external) face of the stack assembly. This exposed edge of the gasket material enables creation of a recess therein to enable access for an electrical connector to a tab portion of a face of a fluid flow field plate, the face being otherwise sealed against the gasket material.

FIG. 7 illustrates a portion of a fuel cell stack 70 of the open cathode variety having a layered construction comprising, in sequence: an electrically conductive anode flow plate 71; an anode gasket 72 and a cathode gasket 74 for sealing against a membrane electrode assembly 73 therebetween; an electrically conductive cathode flow plate 75; and a manifold gasket 76. The anode flow plate 71 defines a plurality of fluid flow distribution channels in a surface thereof for flow of anode fluid (e.g. hydrogen) therethrough in the manner as discussed above. The cathode flow plate 75 comprises a corrugated structure 75a in which the corrugations provide flow channels 75b for passage of air through the stack 70 from one ventilation face 77 of the stack 70 to an opposing ventilation face on the opposite side of the stack (not visible in FIG. 7). These flow channels 75a may serve to deliver both cathode oxidant fluid (e.g. air) to the cathode surfaces and cooling fluid (e.g. air) through the fuel cell stack.

At one end 79 of the stack 70, or at both ends of the stack (e.g. end 79 and the opposing end not visible in FIG. 7), a fluid distribution plenum or manifold 78 may be provided which extends through the height of the stack 70 to provide anode fluid to channels in the anode flow plates 71 as described above with reference to FIG. 2. This manifold 78 may be defined by apertures in each flow plate 71, 75 and in the manifold gaskets 76 disposed between each anode and cathode flow plate pair 71, 75. The manifold gaskets 76 may generally be of an appropriate thickness t to accommodate the height of the corrugations of the corrugated structure 75a, or may comprise multiple layers to make up this thickness t. The manifold gaskets each have an exposed face 81 which effectively defines an open (e.g. externally accessible) face of the stack 70. In the arrangement as shown, each manifold gasket 76 has a recess 80 defined in the exposed face 81 which effectively forms an opening in the open face of the stack assembly 70 suitable for receiving an electrical connector for making electrical connection to at least one of the anode flow plate 71 and cathode flow plate 75. The electrical connector assembly may comprise a blade 41 such as described in connection with FIGS. 3 and 4.

In the example shown, the recess 80 in the exposed face 81 is formed by way of a channel 82 in one surface (e.g. the upper surface as shown) of the manifold gasket 76 extending part way into the gasket from the exposed face 81. The recess 80 preferably extends through only a portion of the thickness t of the manifold gasket 76. If the manifold gasket 76 is formed from multiple layers, the channel 82 could be defined by a cut out section of an upper layer or layers, leaving a lower layer uncut. The recess 80 is defined on a top side by the anode flow plate 71, and on a bottom side by the base of the channel 82, and on the two lateral sides by the sidewalls of the channel 82.

The base of the channel 82 may define a retention feature suitable for assisting in retaining an electrical connector assembly (e.g. blade 41) that is inserted into the recess. The retention feature may comprise a ribbed surface on the base of the channel 82 and/or on one or more of the sidewalls of the channel 82. In the arrangement shown, the ribbed surface comprises longitudinal ribs 83 each extending into the recess from the exposed face 81 of the manifold gasket 76 to serve as a longitudinal guide to an electrical connector assembly being inserted therein. Alternatively, or in addition, the ribbed surface could comprise ribs extending transversely across the recess 80 to increase friction between a connector assembly and the recess 80. As described in connection with FIG. 2a, the ribbed surface may generally comprise a suitable contoured or profiled surface of the gasket material which enhances the friction between a connector assembly when passing into a housing structure embodied by the recess 80 and generally formed by the gasket material of the manifold gasket 76. The ribbed surface may comprise a series of detents, ridges, ripples, notches, barbs or other surface texture or surface profile features which cooperate with or interengage with features of a connector blade of a connector assembly. Similarly, as described in connection with FIG. 2, a retention feature may additionally or instead be provided on the surface of the anode flow plate 71 in analogous manner to that described in connection with the exposed surface 24a of tab 20 in FIG. 2, to assist in retention of a connector blade. The retention feature may be applied to the surface of an anode flow plate (or cathode flow plate, or both) which is associated with (e.g. adjacent to or defining one wall of) a respective recess 80 into which a connector blade is received.

As can be seen in the example of FIG. 7, the manifold gasket 76 may lie between the anode plate 71 and the cathode plate 75. The recess 80 formed by channel 82 can be defined in either the face of the manifold gasket 76 adjacent to the anode flow plate 71 (as shown), or the channel could be defined in the face of the manifold gasket 76 adjacent to the cathode flow plate 75 (e.g. an ‘inverted’ channel in the orientation of fuel cell stack assembly shown in FIG. 7). In a still further arrangement, the recess 80 could extend through the entire thickness t of the manifold gasket 76 such that a blade 41 of a connector assembly connector assembly to be inserted therein would make direct electrical contact with both the anode plate 71 and the cathode plate 75. In this instance, one or more retention features could be provided on the sidewalls of the recess 80 as defined by the manifold gasket material. In the arrangement of FIG. 7, the anode flow plate 71 and the cathode flow plate 75 are in electrical contact with one another via the crests of each corrugation.

The example of FIG. 7 illustrates a fuel cell stack assembly in which the recesses 80 are formed in a manifold gasket 76 which may be separate from an anode gasket or a cathode gasket. However, the recesses 80 may be formed in any gasket of the fuel cell stack assembly adjacent to an electrically conductive plate and of sufficient thickness to allow an electrical connector assembly (e.g. blade 41) to be received therein. In the arrangement of FIG. 7, the manifold gasket 76 need not be electrically insulating since it lies between an anode flow plate and a cathode flow plate which are electrically connected. However, a gasket electrically isolating an anode plate and a cathode plate, or electrically isolating bipolar plates of adjacent cells, would need to be electrically insulating.

The fuel cell stack arrangements described above may use any suitable male-type electrical connection assembly such as an assembly similar to those described in connection with FIGS. 3 and 4. The recesses 80 need not be formed in the manifold gasket layer (or other gasket layer) of every fuel cell in the stack if a voltage connection tab is not required for every cell. The recesses 80 may be provided for every cell but the connection modules 40 may be provided with blades 41 only at selected plate/cell positions in the stack, as discussed in connection with the arrangements of FIGS. 2 to 6. Multiple recesses 80 may be provided at different positions within the stack assembly for staggered positioning of connection modules 40, if required.

The fuel cell stack arrangements described above may also be adapted to provide fluid cooling, for example liquid cooling, of the portion of the plate elements that provide the electrical connection area. For example, the tabs (e.g. tabs 20) of the plate elements 11 can be fluid cooled, or the portions of the electrically conductive fluid flow plates (e.g. anode or cathode flow plate 71, 75) that are adjacent to the recesses 80 receiving an electrical connector can be fluid cooled.

In the example of FIG. 2, the electrical connector tab 20 is preferably an integrally formed part of the plate element 11, and the plate element defines flow channels 12 therein. In a modification thereto, the underside of the plate element 11 (as viewed in FIG. 2) may include a set of flow channels for delivery of cooling fluid (e.g. water) to the electrical connector tab 20. FIG. 8 shows a suitable modification to the plate element 11 of FIG. 2a. As exemplified in the arrangement of FIG. 8, the plate element 11 may include a series of fluid flow channels 90 in the face 24b on the reverse side of the tab 20. The flow channels 90 may extend around the plate beneath the gasket material 15 in any suitable pattern which allows fluid flow into the vicinity of the tab 20, and preferably traversing the tab 20 on the opposite face to the exposed face 24a, thereby enabling fluid cooling of the tab itself.

The flow channels may comprise serpentine channels that extend into and across the area of the tab 20. The flow channels may be of generally uniform width to cover a suitable area of the tab 20 area, and/or may include galleries capable of provide a greater volume of coolant at positions in the tab 20 area.

The flow channels 90 can assist in enabling higher current draw through the tab 20 than would otherwise be possible. This can be of particular benefit when the plate element 11 is particularly thin and/or of low thermal mass, and/or when it is useful to be able to sometimes draw significantly higher current from a tab 20 than would be normally required for cell voltage monitoring. Such flow channels 90 could alternatively, or additionally be provided in the gasket material 15 itself adjacent to the portion of the plate element 11 defining the tab 20.

The coolant flow channels 90 may be fed from a suitable fluid distribution plenum similar to that shown as feature 17 on FIG. 2. The coolant flow channels 90 could be extensions of the anode or cathode flow channels 12 of the plate 11, particularly where the anode or cathode fluid flows are sufficient to provide cooling to the tabs. Alternatively, the coolant flow channels 90 could be extensions of specific water or other coolant flow channels that extend across the active area of the plates (e.g. the areas covered by gas diffusion layers 13 as shown in FIG. 2). Alternatively, the coolant flow channels may be specific channels for the tabs 20 and fed by a suitable dedicated plenum 17. In a general aspect, the coolant flow channels may be defined in the face 24b of the laterally projecting tab 20 and/or in the gasket material 25 covering the face 24b of the laterally projecting tab 20.

A similar modification can readily be applied to the fuel cell stack arrangement exemplified by FIG. 7. In such a modification, the coolant flow channels may be provided as channels in the face of the cathode flow plate 75 immediately adjacent to the manifold gasket 76, and overlying the channel 82, for example. The coolant flow channels may generally be provided in the anode or cathode flow plates 71, 75 in faces sealed against the gaskets 76 and in the vicinity of the electrical connection areas defined by recesses 80. Thus, in a general aspect, one or more of the cells in the stack may have a coolant flow channel defined in an electrically conductive plate such as anode flow plate 71 or cathode flow plate 75 and/or in the gasket 76 overlying such a plate, and the coolant flow channel may be located in a position overlying the recess 80 to thereby cool a portion of the plate which is exposed by the channel 82 for connection to an electrical connector assembly, such as blade 41.

By providing such direct fluid cooling to the portion of the electrically conductive plate to which an electrical connector assembly is to be attached, the electrically conductive plate in the vicinity of the electrical connection area can have a very low mass and small surface area yet still provide a good current capacity without damage through overheating. By using liquid cooling which may already be available elsewhere on the plate, it is convenient, efficient and low cost to extend the cooling flow path or paths (and thereby extend the temperature-controlled surfaces of the plates) to the electrical connection area of the plates.

Other embodiments are intentionally within the scope of the accompanying claims.

1. A fluid flow field plate for an electrochemical fuel cell comprising an electrically conductive plate element having a peripheral edge encapsulated in an electrically insulating gasket material, the plate element having a laterally projecting tab with a first face covered by the peripheral gasket material and a second face at least partially exposed through the gasket material.

2. The fluid flow field plate of claim 1 in which at least one edge of the laterally projecting tab is covered by the peripheral gasket material.

3. The fluid flow field plate of claim 1 in which at least two edges of the laterally projecting tab are covered by the peripheral gasket material.

4. The fluid flow field plate of claim 1 in which the leading edge of the laterally projecting tab is covered by the peripheral gasket material.

5. The fluid flow field plate of claim 1 in which the gasket material defines a retention feature for retaining an electrical connector coupled to the laterally projecting tab.

6. The fluid flow field plate of claim 5 in which the retention feature comprises a barb on an exposed surface of the gasket material extending over the laterally projecting tab.

7. The fluid flow field plate of claim 5 in which the retention feature comprises a ribbed exposed surface of the gasket material overlying the first face.

8. The fluid flow field plate of claim 1 comprising a bipolar plate having fluid distribution channels in both faces of the electrically conductive plate element.

9. The fluid flow field plate of claim 1 in which the electrically insulating gasket material extends around the complete periphery of the electrically conductive plate element, and defines fluid distribution channels in the gasket material on at least one peripheral edge of the plate element and defines a protective structure for the laterally projecting tab on at least one different peripheral edge of the plate element.

10. The fluid flow field plate of claim 1 further including fluid coolant flow channels defined in the first face of the laterally projecting tab and I or in the gasket material covering the first face of the laterally projecting tab.

11. The fluid flow field plate of claim 1 in which the laterally projecting tab defines a retention feature for retaining an electrical connector coupled to the laterally projecting tab.

12. The fluid flow field plate of claim 11 in which the retention feature comprises contoured or profiled exposed surface of the laterally projecting tab.

13. A fuel cell stack comprising a plurality of layers, at least some of said layers each comprising a fluid flow field plate according to claim 1, thereby defining a plurality of electrically conductive connection tabs extending outwardly from at least one face of the stack, each electrically conductive connection tab being protected on plural edges by the gasket material of the plurality of layers, the gasket material collectively defining a housing structure for the plurality of connection tabs.

14. The fuel cell stack of claim 13 in which the housing structure comprises two end walls protecting edges of the connection tabs and defining a receptacle therebetween for receiving an electrical connector module.

15. The fuel cell stack of claim 13 further including an electrical connector module configured to engage with the plural electrically conductive connection tabs and the gasket material for separate electrical connection to each of the tabs.

16. The fuel cell stack of claim 15 in which the electrical connector module engages with retention features disposed on the gasket material.

17. The fuel cell stack of claim 16 in which the retention features comprise one or more of a barb or barbs on the housing structure and ribbed exposed surfaces of the gasket material of the housing structure.

18. The fuel cell stack of claim 15 in which the width of the electrical connector module is substantially less than the width of the electrically conductive connection tabs such that the electrical connector module can be engaged with the tabs at a number of different positions along a peripheral edge of the stack and/or such that multiple such electrical connector modules could be engaged with tabs of the stack simultaneously at different positions along the peripheral edge of the stack.

19. The fuel cell stack of claim 15 in which the electrical connector module comprises a plurality of blades spaced from one another with a pitch that is equal to or an integer multiple of the pitch of the plates in the stack, each blade comprising a spring metal component for engagement with the second face of a laterally projecting tab and for simultaneous engagement with the gasket material covering the first face of an opposing, adjacent laterally projecting tab.

20-29. (canceled)

30. A method of making electrical connections to flow field plates of a fuel cell stack comprising:
forming a plurality of fluid flow field plates each comprising an electrically conductive plate element having a peripheral edge encapsulated in an electrically insulating gasket material, the plate element having a laterally projecting tab with a first face covered by the peripheral gasket material and a second face at least partially exposed through the gasket material;
stacking the fluid flow field plates together to form a fuel cell stack with aligned laterally projecting tabs, such that the gasket material defines a housing for said tabs.

31. The method of claim 30 further comprising:
connecting an electrical connector module to said tabs by engagement into a receptacle defined by the housing, wherein the engagement of the electrical connector module is with the tabs and the gasket material.

32-33. (canceled)
